(19) United States
(12) Patent Application Publication
(10) Pub. No.: US 2024/0196250 A1
(43) Pub. Date: Jun. 13, 2024

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP); Jing Wang, Beijing (CN); Lan Chen, Beijing (CN)

(73) Assignee: NTT DOCOMO, INC., Tokyo (JP)

(21) Appl. No.: 18/286,481

(22) PCT Filed: Mar. 29, 2022
(86) PCT No.: PCT/JP2022/015526

§ 371 Date: Oct. 11, 2023

(30) Foreign Application Priority Data
Apr. 12, 2021 (JP) 2021-067096

(51) Int. Cl. H04W 24/10; H04B 17/318

(52) U.S. Cl. CPC H04W 24/10; H04B 17/318

(57) ABSTRACT

A terminal according to one aspect of the present disclosure includes: a control section that determines whether an event to be a trigger of a CSI report occurs, based on a measurement result related to channel state information (CSI) of at least one of a serving cell, a neighbour cell, a primary cell, a primary secondary cell, and a secondary cell; and a transmitting section that transmits an aperiodic CSI report when the event occurs. According to one aspect of the present disclosure, an aperiodic CSI report can be appropriately performed.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+(plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

Layer-1/layer-2 (layer 1/layer 2 (L1/L2)) inter-cell mobility to facilitate DL/UL beam management that is more efficient (achieves lower latency and overhead) in future radio communication systems is under study.

In L1/L2 inter-cell mobility, serving cell change is possible by using a function such as beam control without radio resource control (RRC) reconfiguration. In other words, transmission/reception with a non-serving cell is possible without handover. For handover, RRC reconnection is needed, for example, which causes a data communication unavailable period. Hence, L1/L2 inter-cell mobility with no need of handover is preferable.

However, in a case of employing at least one of inter-cell mobility including a non-serving cell and a multi-TRP scenario, an event for triggering an aperiodic CSI report to be initiated by a UE has not been made clear. Unless the event is made clear, the CSI report is not performed appropriately, which may reduce throughput or deteriorate communication quality.

Thus, an object of the present disclosure is to provide a terminal, a radio communication method, and a base station that allow an aperiodic CSI report to be appropriately performed.

### Solution to Problem

A terminal according to one aspect of the present disclosure includes: a control section that determines whether an event to be a trigger of an aperiodic CSI report occurs, based on a measurement result related to channel state information (CSI) of at least one of a serving cell, a neighbour cell, a primary cell, a primary secondary cell, and a secondary cell; and a transmitting section that transmits the aperiodic CSI report when the event occurs.

### Advantageous Effects of Invention

According to one aspect of the present disclosure, a periodic CSI report can be appropriately performed.

### BRIEF DESCRIPTION OF DRAWINGS

FIGS. 1A and 1B are diagrams to show examples of a configuration of a TCI state.

FIG. 2 is a flowchart to show an example of processing according to a first embodiment.

FIG. 3 is a diagram to show a first example of a MAC CE used for CSI report.

FIG. 4 is a diagram to show a second example of the MAC CE used for CSI report.

FIG. 5 is a diagram to show a third example of the MAC CE used for CSI report.

FIG. 6 is a diagram to show a fourth example of the MAC CE used for CSI report.

FIG. 7 is a diagram to show a fifth example of the MAC CE used for CSI report.

FIG. 8 is a diagram to show a sixth example of the MAC CE used for CSI report.

FIG. 9 is a diagram to show an example of a schematic structure of a radio communication system according to one embodiment.

FIG. 10 is a diagram to show an example of a structure of a base station according to one embodiment.

FIG. 11 is a diagram to show an example of a structure of a user terminal according to one embodiment.

FIG. 12 is a diagram to show an example of a hardware structure of the base station and the user terminal according to one embodiment.

### DESCRIPTION OF EMBODIMENTS

### (CSI Report)

In NR, a UE measures a channel state by using a certain reference signal (or a resource for the reference signal) and feeds back (reports) channel state information (CSI) to a base station.

The UE may measure the channel state by using a channel state information-reference signal (CSI-RS), a synchronization signal/broadcast channel (Synchronization Signal/Physical Broadcast Channel (SS/PBCH)) block, a synchronization signal (SS), a demodulation reference signal (DMRS), or the like.

A CSI-RS resource may include at least one of a non zero power (NZP) CSI-RS and CSI-Interference Management (IM). The SS/PBCH block is a block including synchronization signals (e.g., a primary synchronization signal (PSS), a secondary synchronization signal (SSS)) and a PBCH (and a corresponding DMRS) and may also be referred to as an SS block (SSB) and so on. An SSB index may be given to a time location of the SSB in a half frame.

Note that the CSI may include at least one of a channel quality indicator (CQI), a precoding matrix indicator (PMI), a CSI-RS resource indicator (CRI), an SS/PBCH block resource indicator (SSBRI), a layer indicator (LI), a rank indicator (RI), a Layer 1 (L1)-Reference Signal Received Power (RSRP) (reference signal received power in layer 1), L1-Reference Signal Received Quality (RSRQ), an L1-Signal to Interference plus Noise Ratio (SINR), an L1-Signal to Noise Ratio (SNR), and the like.

The CSI may include a plurality of parts. A first part of the CSI (CSI part 1) may include information with a relatively small number of bits (e.g., RI). A second part of the CSI (CSI part 2) may include information with a relatively large number of bits (e.g., CQI), such as information defined based on CSI part 1.

As a method of feeding back CSI, (1) a periodic CSI (P-CSI) report, (2) an aperiodic CSI (A(AP)-CSI) report, (3) a semi-persistent CSI report (SP-CSI) report, and the like are studied.

The UE may be notified of information related to the CSI report (which may also be referred to as CSI report configuration information) by using higher layer signaling or physical layer signaling (e.g., downlink control information (DCI)), or a combination of these. The CSI report configuration information may be configured by using an RRC information element “CSI-ReportConfig,” for example.

Here, for example, the higher layer signaling may be any one or combination of Radio Resource Control (RRC) signaling, Medium Access Control (MAC) signaling, broadcast information, and the like.

The MAC signaling may use, for example, a MAC control element (MAC CE), a MAC Protocol Data Unit (MAC PDU), or the like. The broadcast information may be, for example, a master information block (MIB), a system information block (SIB), minimum system information (Remaining Minimum System Information (RMSI)), other system information (OSI), or the like.

The CSI report configuration information may include, for example, information related to report periodicity, offset, and the like, and may be expressed in a certain time unit (on a per slot basis, on a per subframe basis, on a per symbol basis, or the like). The CSI report configuration information may include a configuration ID (CSI-ReportConfigId). A parameter such as a type of a CSI report method (for example, whether the type is SP-CSI) or report periodicity may be specified by the configuration ID. The CSI report configuration information may include information (CSI-ResourceConfigId) indicating which signal (or a resource for which signal) is to be used to report the measured CSI.

### (Beam Management)

For Rel-15 NR, a method of beam management (BM) has been studied. For the beam management, it is studied to perform beam selection, based on an L1-RSRP reported by a UE. Changing (switching) a beam of a certain signal/channel may be equivalent to changing (Transmission Configuration Indication state) of the signal/channel.

Note that a beam selected through the beam selection may be a transmit beam (Tx beam) or may be a receive beam (Rx beam). The beam selected through the beam selection may be a beam of a UE or may be a beam of a base station.

The UE may report (transmit) a measurement result for the beam management by using a PUCCH or a PUSCH. The measurement result may be, for example, CSI including at least one of an L1-RSRP, an L1-RSRQ, an L1-SINR, an L1-SNR, and the like. The measurement result may be referred to as beam measurement, a beam measurement result, a beam report, a beam measurement report, and the like.

The CSI measurement for the beam report may include interference measurement. The UE may measure channel quality, interference, and the like by using a resource for the CSI measurement to derive a beam report. The resource for the CSI measurement may be, for example, at least one of an SS/PBCH block resource, a CSI-RS resource, other reference signal resources, and the like. Configuration information of a CSI measurement report may be configured for the UE by using higher layer signaling.

The beam report may include a result of at least one of the channel quality measurement and the interference measurement. The result of the channel quality measurement may include the L1-RSRP, for example. The result of the interference measurement may include the L1-SINR, the L1-SNR, the L1-RSRQ, any other indicators related to interference (e.g., any indicator that is not the L1-RSRP), or the like.

Note that the resource for the CSI measurement for the beam management may be referred to as a resource for beam measurement. The signal/channel as a target of the CSI measurement may be referred to as a signal for beam measurement. The CSI measurement/report may be interpreted as at least one of measurement/report for beam management, beam measurement/report, radio link quality measurement/report, and the like.

Regarding CSI report configuration information considering beam management of current NR is included in an RRC information element “CSI-ReportConfig.” Information in the RRC information element “CSI-ReportConfig” will be described.

The CSI report configuration information (CSI-ReportConfig) may include report quantity information (“report quantity,” which may be expressed using an RRC parameter “reportQuantity”), which is information of a parameter to be reported. The report quantity information is defined using a type of ASN.1 object called “choice.” Hence, one of parameters defined as the report quantity information (cri-RSRP, ssb-Index-RSRP, and the like) is configured.

The UE configured with a higher layer parameter (e.g., an RRC parameter “groupBasedBeamReporting”) included in the CSI report configuration information being enabled may include, for each report configuration, a plurality of resource IDs for beam measurement (e.g., SSBRIs, CRIs) and a plurality of measurement results (e.g., L1-RSRPs) corresponding to the resource IDs, in the beam report.

The UE configured with the number of report-target RS resources being one or more by a higher layer parameter (e.g., an RRC parameter “nrofReportedRS”) included in the CSI report configuration information may include, for each report configuration, one or more resource IDs for beam measurement and one or more measurement results (e.g., an L1-RSRP (s)) corresponding to the resource ID(s), in the beam report.

### (TCI, Spatial Relation, QCL)

For NR, control of reception processing (for example, at least one of reception, demapping, demodulation, and decoding) and transmission processing (for example, at least one of transmission, mapping, precoding, modulation, and coding) of at least one of a signal and a channel (expressed as a signal/channel) in a UE, based on a transmission configuration indication state (TCI state) has been under study.

The TCI state may be a state applied to a downlink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information, or the like. The TCI state may be configured for the UE for each channel or for each signal.

QCL is an indicator indicating statistical properties of the signal/channel. For example, when a certain signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have different parameter(s) (or parameter set (s)) that can be assumed to be the same, and such parameter (s) (which may be referred to as QCL parameter (s)) are described below:
QCL type A (QCL-A): Doppler shift, Doppler spread, average delay, and delay spread
QCL type B (QCL-B): Doppler shift and Doppler spread
QCL type C (QCL-C): Doppler shift and average delay
QCL type D (QCL-D): Spatial reception parameter

A case that the UE assumes that a certain control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

In the present disclosure, for example, the higher layer signaling may be any one or combination of Radio Resource Control (RRC) signaling, Medium Access Control (MAC) signaling, broadcast information, and the like.

The MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

The physical layer signaling may be, for example, downlink control information (DCI).

A channel for which the TCI state or the spatial relation is configured (indicated) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), and a reference signal for QCL detection (also referred to as a QRS).

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An information element of the TCI state (“TCI-state IE” of RRC) configured using higher layer signaling may include one or a plurality of pieces of QCL information (“QCL-Info”). The QCL information may include at least one of information related to the RS to have a QCL relationship (RS relation information) and information indicating a QCL type (QCL type information). The RS relation information may include information such as an index of the RS (for example, an SSB index, or a non-zero-power CSI-RS (NZP CSI-RS) resource ID (Identifier)), an index of a cell in which the RS is located, and an index of a Bandwidth Part (BWP) in which the RS is located.

In Rel-15 NR, both an RS of QCL type A and an RS of QCL type D or only an RS of QCL type A may be configured as a TCI state of at least one of a PDCCH and a PDSCH for a UE.

When a TRS is configured as the RS of QCL type A, it is assumed for the TRS, different from a reference signal for demodulation (DeModulation Reference Signal (DMRS)) of the PDCCH or the PDSCH, that the same TRS is transmitted periodically for a long time period. The UE measures the TRS and can hence calculate average delay, delay spread, and the like.

Since the UE configured with the TRS as the RS of QCL type A in the TCI state of the DMRS of the PDCCH or the PDSCH can assume that the DMRS of the PDCCH or the PDSCH and the TRS have the same QCL type A parameter (average delay, delay spread, or the like), the UE can obtain the type A parameter (average delay, delay spread, or the like) of the DMRS of the PDCCH or the PDSCH, from the measurement result of the TRS. When the UE performs channel estimation for at least one of the PDCCH and the PDSCH, the UE can use the measurement result of the TRS to perform channel estimation at higher accuracy.

The UE configured with the RS of QCL type D can determine a UE receive beam (spatial domain receive filter, UE spatial domain receive filter) by using the RS of QCL type D.

An RS having the TCI state of QCL type X may mean an RS in a relationship of QCL type X with (a DMRS of) a certain channel/signal, and this RS may be referred to as a QCL source having the TCI state of QCL type X.

### (Inter-Cell Mobility)

For NR, it is studied that one or a plurality of transmission/reception point (TRP) (multi-TRP (MTRP)) perform DL transmission to a UE. It is also studied that the UE performs UL transmission to the one or plurality of TRPs.

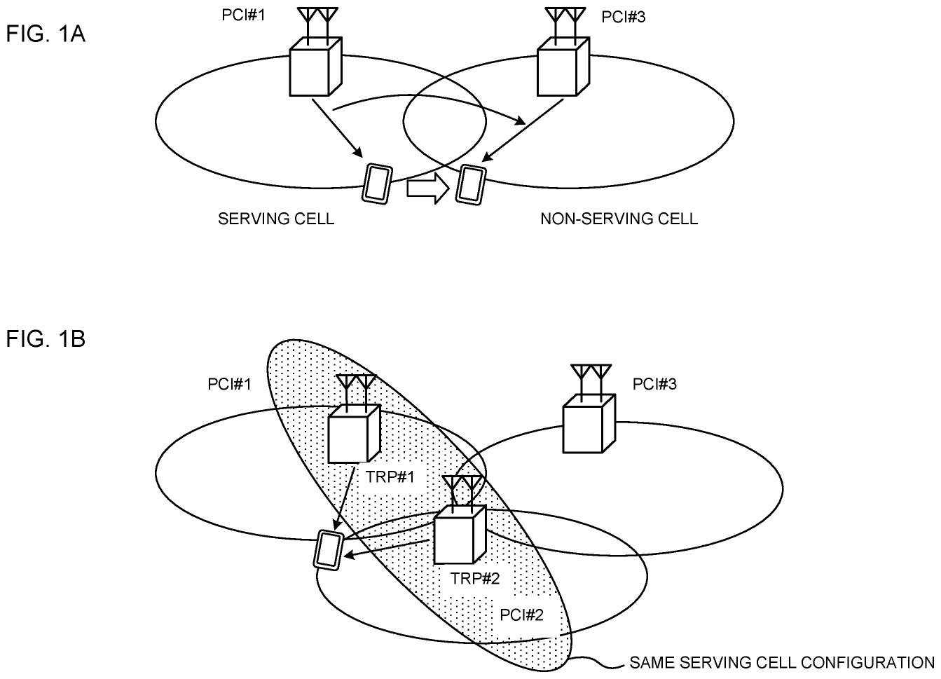

It is considered that a UE receives channels/signals from a plurality of cells/TRPs in inter-cell mobility (e.g., L1/L2 inter cell mobility) (refer to FIGS. 1A and 1B).

FIG. 1A shows an example of inter-cell mobility (e.g., inter-cell mobility of a single TRP) including non-serving cell. The single TRP may mean a case where only one TRP of multi-TRP performs transmission to the UE (which may be referred to as a single-mode). A CORESET pool index may indicate a single TRP. FIG. 1A shows a case where the UE receives channels/signals from a base station/TRP of cell #1 being a serving cell and a base station/TRP of cell #3 not being a serving cell (non-serving cell). For example, this corresponds to a case where the UE switches from cell #1 to cell #3 (e.g., fast cell switch).

In this case, a TCI state may be updated by DCI/MAC CE to dynamically select a port (e.g., an antenna port)/TRP/point. Different physical cell IDs (e.g., PCIs) are configured for cell #1 and cell #3.

FIG. 1B shows an example of a multi-TRP scenario (for example, inter-cell mobility using multi-TRP (Multi-TRP inter-cell mobility)). FIG. 1B shows a case where the UE receives channels/signals from TRP #1 and TRP 2. FIG. 1B shows a case where TRP #1 is present in cell #1 (PCI #1), and TRP #2 is present in cell #2 (PCI #2).

The multi-TRP (TRPs #1 and #2) may be connected to each other via ideal/non-ideal backhaul to exchange information, data, and the like. From each TRP of the multi-TRP, a different codeword (Code Word (CW)) and a different layer may be transmitted. As one mode of multi-TRP transmission, non-coherent joint transmission (NCJT) may be employed as shown in FIG. 1B. FIG. 1B shows a case where NCJT is performed among a plurality of cells (for example, cells with different PCIs). Note that the same serving cell configuration may be used/configured for TRP #1 and TRP #2.

In NCJT, for example, TRP #1 performs modulation mapping on a first codeword and performs layer mapping to transmit a first signal/channel (e.g., PDSCH) by using first precoding in a first number of layers (e.g., two layers). TRP #2 performs modulation mapping on a second codeword and performs layer mapping to transmit a second signal/channel (e.g., PDSCH) by using second precoding in a second number of layers (e.g., two layers).

The plurality of PDSCHS (multi-PDSCH) in NCJT may be defined to partially or entirely overlap each other in at least one of the time and frequency domains. In other words, the first PDSCH from TRP #1 and the second PDSCH from TRP #2 may overlap each other in terms of at least one of time and frequency resources.

It may be assumed that the first PDSCH and the second PDSCH are not in a quasi-co-location (QCL) relationship (are not quasi-co-located). Multi-PDSCH reception may be interpreted as simultaneous reception of PDSCHs that are not of a certain QCL type (e.g., QCL type D).

The plurality of PDSCHs from the multi-TRP (which may be referred to as multi-PDSCH (multiple PDSCHs)) may be scheduled by using one piece of DCI (single DCI (S-DCI), single PDCCH) (single-master mode). The one piece of DCI may be transmitted from one TRP of the multi-TRP. A configuration of using one piece of DCI in the multi-TRP may be referred to as single-DCI-based multi-TRP (mTRP/MTRP).

A case where each TRP of the multi-TRP transmits part of a control signal to the UE and the multi-TRP transmits data signals (which may be referred to as a master-slave mode) may be employed.

A plurality of PDSCHs from the multi-TRP may be scheduled by using a plurality of respective pieces of DCI (multi-DCI (M-DCI), multi-PDCCH (multiple PDCCHs)) (multi-master mode). The plurality of pieces of DCI may be transmitted from the respective TRPs of the multi-TRP. A configuration using a plurality of pieces of DCI in the multi-TRP may be referred to as multi-DCI-based multi-TRP (mTRP/MTRP).

It may be assumed that the UE transmits separate CSI reports related to the respective TRPs to the respective different TRPs. Such CSI feedback may be referred to as a separate feedback, separate CSI feedback, and the like. In the present disclosure, “separate” may be interpreted as “independent” and vice versa.

It is studied to use a mechanism of a TCI state in Rel. 15/16 for such inter-cell mobility using multi-TRP and use a new mechanism for inter-cell mobility using a single TRP. In the mechanism of a TCI state in Rel. 15/16, a CSI-RS can be configured as a TCI state of a PDSCH/PDCCH (DMRS of the PDSCH/PDCCH) (the TCI state of the PDSCH/PDCCH can refer to the CSI-RS). An SSB can be configured as the TCI state of the CSI-RS. However, an SSB cannot be directly configured as the TCI state of the PDSCH/PDCCH. It is studied to (directly) configure an SSB as a TCI state of a PDSCH/PDCCH in a new mechanism in Rel. 17 using a unified TCI state (single-TRP inter-cell mobility).

Note that X being configured as a TCI state of a PDSCH/DCCH, a TCI state of a PDSCH/PDCCH referring to X, and a QCL source of a PDSCH/PDCCH being X may be interpreted interchangeably.

Such an inter-cell mobility (L1/L2 inter-cell mobility) as that described above to facilitate DL/UL beam management that is more efficient (achieves lower latency and overhead) in future radio communication systems is under study.

In L1/L2 inter-cell mobility, serving cell change is possible by using a function such as beam control without RRC reconfiguration. In other words, transmission/reception with a non-serving cell is possible without handover. For handover, RRC reconnection is needed, for example, which causes a data communication unavailable period. Hence, L1/L2 inter-cell mobility with no need of handover is preferable.

Regarding L1/L2-centric inter-cell mobility, at least one of methods 1 and 2 below may be supported for L1/L2 centric report of a neighbour cell.

Method 1: A base station (gNB) may trigger a CSI report of a neighbour cell. The base station (gNB) may be configured with a PCI and a MeasObject for a CSI report/CMR set/CMR resource. CMR may be a CSI-RS/SSB for mobility derived according to the MeasObject and the PCI.

Method 2: An event drive mechanism in a beam level for L1/L2-centric inter-cell mobility may be employed. After initialization by an event triggered by L3 mobility measurement, an L1-RSRP report including a new candidate beam and neighbour cell information (PCI and the like) may be performed by a MAC-CE.

To save resources and power consumption for a periodic CSI report, it is preferable to support a beam/CSI report of a cell by a trigger of an event, when the best SSB (RSRP) of a non-serving cell being a more appropriate candidate is sufficiently better than that of the serving cell. Note that the report may include a candidate SSB (s)/cell ID(s). The UE may reuse a normal SR resource or a dedicated SR resource to request UL permission for the report.

However, in a case of employing at least one of inter-cell mobility including a non-serving cell and a multi-TRP scenario, an event for triggering an aperiodic CSI report to be initiated by a UE has not been made clear. Moreover, a content of a CSI report triggered by an event and signaling for transmitting the CSI report are not made clear. Unless these are made clear, the CSI report is not performed appropriately, which may reduce throughput or deteriorate communication quality.

Hence, the inventors of the present invention came up with the idea of a terminal capable of appropriately performing an aperiodic CSI report.

Embodiments according to the present disclosure will be described in detail with reference to the drawings as follows. The radio communication methods according to respective embodiments may each be employed individually, or may be employed in combination.

In the present disclosure, a CSI report, a beam report, and an L1 beam report may be interpreted interchangeably. Report and measurement may be interpreted interchangeably.

In the present disclosure, a panel, an Uplink (UL) transmission entity, a point, a TRP, a spatial relation, a control resource set (CORESET), a PDSCH, a codeword, a base station, an antenna port for a certain signal (e.g., a reference signal for demodulation (DeModulation Reference Signal (DMRS) port)), an antenna port group for a certain signal (e.g., a DMRS port group), a group for multiplexing (e.g., a code division multiplexing (CDM) group, a reference signal group, a CORESET group), a CORESET pool, a CORESET subset, a CW, a redundancy version (RV), and a layer (MIMO layer, transmission layer, spatial layer) may be interpreted interchangeably. A panel Identifier (ID) and a panel may be interpreted interchangeably. In the present disclosure, a TRP index, a TRP ID, a CORESET pool index, an ordinal number (first, second) of each of two TCI states, and a TRP may be interpreted interchangeably.

In the present disclosure, a beam, a spatial domain filter, a spatial setting, a TCI state, a UL TCI state, a unified TCI state, a unified beam, a common TCI state, a common beam, a TCI assumption, a QCL assumption, a QCL parameter, a spatial domain receive parameter, a UE spatial domain receive filter, a UE receive beam, a DL beam, a DL receive beam, a DL precoding, a DL precoder, a DL-RS, an RS having a TCI state/QCL assumption of QCL type D, an RS having a TCI state/QCL assumption of QCL type A, a spatial relation, a spatial domain transmission filter, a UE spatial domain transmission filter, a UE transmit beam, a UL beam, a UL transmit beam, a UL precoding, a UL precoder, and a PL-RS may be interpreted interchangeably. In the present disclosure, a QCL type X-RS, a DL-RS associated with QCL type X, a DL-RS of QCL type X, a source of a DL-RS, an SSB, a CSI-RS, and an SRS may be interpreted interchangeably.

In the present disclosure, a single TRP, a channel using a single TRP, a channel using one TCI state/spatial relation, multi-TRP not being enabled by RRC/DCI, a plurality of TCI states/spatial relations not being enabled by RRC/DCI, and one CORESET pool index (CORESETPoolIndex) value being not configured for any CORESET and any code point of a TCI field not being mapped to two TCI states may be interpreted interchangeably.

In the present disclosure, multi-TRP, a channel using multi-TRP, a channel using a plurality of TCI states/spatial relations, multi-TRP being enabled by RRC/DCI, a plurality of TCI states/spatial relations being enabled by RRC/DCI, and at least one of multi-TRP based on a single piece of DCI and multi-TRP based on multi-DCI may be interpreted interchangeably.

In the present disclosure, a cell, a CC, a carrier, a BWP, and a band may be interpreted interchangeably.

In the present disclosure, an index, an ID, an indicator, and a resource ID may be interpreted interchangeably.

In the present disclosure, “A/B” may be interpreted as “at least one of A and B.”

In the present disclosure, an RS, a beam, a measurement result, and a configuration of an RS may be interpreted interchangeably. An RS may mean at least one of a CRI and an SSBRI in a CSI report. An L1-RSRP and an L1-SINR may be interpreted interchangeably. An SSB, an SSB index, and an SSBRI may be interpreted interchangeably.

### (Radio Communication Method)

A UE may determine whether an event to be a trigger of a CSI report has occurred, based on a measurement result related to channel state information (CSI) of at least one of a serving cell, a neighbour cell, a primary cell, a primary secondary cell, and a secondary cell, and transmit an aperiodic CSI report when the event has occurred (first embodiment). A condition of this event may be the same (first aspect) as or at least partially different (second aspect) from a condition of an event to be a trigger of an RRM report. The event may occur based on a measurement result of a reference signal received power in layer 1 (L1-RSRP) (2-2 of a second aspect). The UE may transmit the aperiodic CSI report by using a Medium Access Control Control Element (MAC CE), when the event has occurred (second embodiment).

### First Embodiment

### (First Aspect)

By reusing one or a plurality of existing events of Radio Resource Management (RRM) (for example, at least one of events A2 to A6 and I1 below), an aperiodic CSI report may be triggered. Specifically, when at least one of events A2 to A6 and I1 below has occurred (when a condition (s) of the event (s) is satisfied), both an RRM report and a CSI report may be triggered, and the UE may transmit both the RRM report and the CSI report.

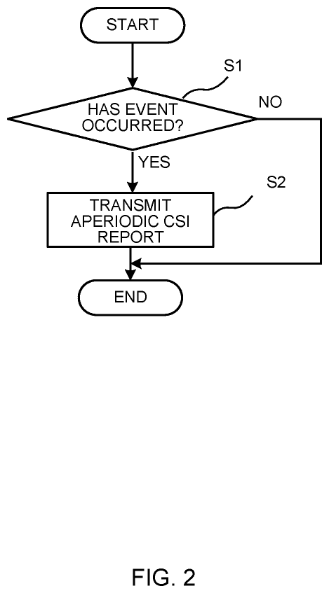

FIG. 2 is a flowchart to show an example of processing according to a first embodiment. The UE determines whether an event (for example, at least one of events A2 to A6 and I1 below) has occurred (S1). When it is YES in S1, the UE transmits an aperiodic CSI report (and an RRM report) (S2), and when it is NO, the UE terminates the processing related to the first embodiment. The processing in FIG. 2 may be repeatedly performed for each certain period.

In the present disclosure, an aperiodic CSI report being triggered and the UE transmitting an aperiodic CSI report may be interpreted interchangeably. A CSI report, an L1 beam report, and a beam report may be interpreted interchangeably.

The measurement result may be a measurement result of at least one of an RSRP (L1-RSRP/L3-RSRP), an RSRQ, and an SINR (RS-SINR) in events A2 to A6 below. In the conditions of events A2 to A6 below, “bad” may mean “low,” and “good” may mean “high.” In the conditions of events A2 to A6, an SpCell may mean a special cell or may mean at least one of a Primary Cell (PCell) and a Primary Secondary Cell (PSCell). In events A2 to A6 and I1 below, a parameter corresponding to a hysteresis may be added to/subtracted from the measurement result. Thresholds may be the same or different from each other. A neighbour cell may be a non-serving cell.

Event A2: A measurement result of a serving cell is worse than a threshold.

Event A3: A measurement result of a neighbour cell (value obtained by adding an offset to the measurement result) is better than a measurement result of an SpCell (value obtained by adding an offset to the measurement result).

Event A4: A measurement result of a neighbour cell (value obtained by adding an offset to the measurement result) is better than a threshold.

Event A5: A measurement result of an SpCell is worse than a first threshold, and a measurement result of a neighbour cell (value obtained by adding an offset to the measurement result) is better than a second threshold.

Event A6: A measurement result of a neighbour cell (value obtained by adding an offset to the measurement result) is better than a measurement result of a serving cell (Secondary Cell (SCell)) (value obtained by adding an offset to the measurement result).

Event I1: A measurement result of interference is higher than a threshold.

According to the first aspect, it is possible to reuse a trigger of an RRM report for a trigger of an aperiodic CSI report, which hence facilitates a configuration.

### (Second Aspect)

One or a plurality of new events (separate from an event for an RRM report) may be defined to trigger an aperiodic L1 beam report (CSI report). The event (s) is similar to events A2 to A6 and I1 above also used for a trigger of an RRM report but may be different from any of events A2 to A6 and I1 (triggers of an RRM report) in at least one of 2-1 to 2-4 below.

((2-1))

A threshold may be different. Specifically, events A2 to A6 and I1 may be used for an L1 beam report (CSI report) by using a threshold different from that of an event for an RRM report.

((2-2))

The event may occur based on a measurement result of a reference signal received power in layer 1 (L1-RSRP). In other words, a comparison based on an L1-RSRP instead of an L3-RSRP may be performed. Alternatively, an L1-RSRP filtered by new filtering with a time scale (periodicity of update/measurement) being between those of the L1-RSRP and the L3-RSRP (or the same as that of the L1-RSRP or the L3-RSRP) may be used. Alternatively, another metric, for example, the L1-SINR, the L3-RSRQ, or the like, may be used. For example, event A2′ below may be used as the new event.

Event A2′: An L1-RSRP measurement result of a serving cell is worse than a threshold.

((2-3))

A basis may be a comparison of a measurement result in one beam level, a level of a plurality of beams (obtained by unifying independent measurement result of a plurality of beams into one value), or a cell level. For example, event A4′ or event A4″ below may be used.

Event A4′: A measurement result of one beam from a neighbour cell is better than a threshold.

Event A4″: A statistic (for example, the average value, the sum, or the like) of measurement values of a plurality of beams (e.g., X best beams) is better than a threshold. X may be fixed or may be configurable by higher layer signaling or the like

((2-4))

The number of beams satisfying the condition (for example, any of events A2 to A6 and I1) may be considered. For example, when X beams satisfy event A4′ (measurement results of X beam (s) from neighbour cells are better than the threshold), the UE may perform CSI report.

Note that an example where at least two of 2-1 to 2-4 above are combined may be employed. For example, A4′″ may be considered as an event obtained by combining 2-2 and 2-3. A4′ ‘ ’′ may be considered as an event obtained by combining 2-2, 2-3, and 2-4.

Event A4′″: An L1-RSRP measurement result of one beam from a neighbour cell is better than a threshold.

Event A4″″: An L1-RSRP of each of X beams from neighbour cell (s) is better than a threshold.

According to the second aspect, it is possible to perform a CSI report at a higher speed than that of a case of using an existing event for an RRM report using RRC.

### (Third Aspect)

By using any combination of two or more events according to the first aspect and the second aspect, an aperiodic L1 beam report (CSI report) may be triggered.

An existing event for an RRM report and one or more events according to the second aspect may be combined. For example, when both event A4 and new event A4′″ have occurred, a CSI report may be triggered.

Two or more events according to the second aspect may be combined. For example, when both event A2′ and new event A4′″ are satisfied, a CSI report may be triggered.

### Second Embodiment

When an aperiodic CSI report is triggered by an event in the UE (for example, by any of the examples in the first embodiment), the UE may transmit a CSI report including at least part of the following contents.

The CSI report includes one or a plurality of non-serving cell index (indices) (PCI (s) or new ID(s) of a non-serving cell (s) with a small bit size (Re-indexing index (indices) of cell (s))). The CSI report may include, but need not necessarily include, one of or both an indication of a serving cell (e.g., new ID=0) and a BWP ID. The new ID (Re-indexing index of cell) will be described later in detail.

A supported maximum number of reports of non-serving cells may be configured by RRC. The actual number of selected/reported non-serving cells may be the maximum number of reports or may be determined by the UE according to measurement results. For example, the UE may transmit a CSI report for only a non-serving cell (s) with an L1/L3 measurement result being larger than a specific threshold. Alternatively, the UE may transmit a CSI report for only one non-serving cell (for example, a non-serving cell with the highest L1/L3 measurement result) to trigger an event. The number of non-serving cell indices may be explicitly or implicitly reported.

One or a plurality of SSB/CSI-RS indices (beam indices) may be included in the CSI report for each non-serving cell. One or a plurality of SSB/CSI-RS indices from the serving cell may be included, but need not necessarily be included, in the CSI report. A supported maximum number of reports of beam indices per cell (or per non-serving/serving cell) may be configured by RRC. The actual number of selected/reported beam indices per cell (or per non-serving/serving cell) may be the maximum number of reports or may be determined by the UE according to measurement results. For example, the UE may report only a beam index (indices) with a measurement result being larger than a specific threshold. Alternatively, the UE may report only a beam(s) with an event being triggered. The number of SSB/CSI-RS indices per cell may be explicitly or implicitly reported.

The CSI report may include an L1-RSRP/L1-SINR value (absolute value or differential value) for each SSB/CSI-RS index. The CSI report may include an L3-RSRP value for each SSB/CSI-RS index, an L3-RSRP value (for example, the statistic (average value, largest value, or the like) of a plurality of reported beams) for each plurality of beams, or an L3-RSRP value for each cell (for each non-serving cell/for each serving cell). The L3-RSRP value may be an absolute value or a differential value.

Whether to include at least part of the contents of the present embodiment in the CSI report may be configured by RRC. For example, whether to report an L3-RSRP may be configured by RRC.

For example, when the UE is configured with a non-serving cell beam report, the number of bits for an L1-RSRP value may be reduced compared with the existing number of bits. Specifically, bits fewer than seven bits may be used for an L1-RSRP, while bits fewer than four bits may be used for a differential L1-RSRP. For example, the number of bits of all the L1-RSRP values may be reduced, or the number of bits of the L1-RSRP value (s) of a non-serving cell (s) may be reduced compared with the number of bits of the L1-RSRP value of the serving cell. In this way, overhead can be reduced. The number of bits to be used may be defined in a specification or may be configured for the UE by higher layer signaling or the like.

A new MAC CE including a Logical Channel ID (LCID) may be defined to be used for the CSI report triggered by the event. Examples of the new MAC CE will be described below. A “report” in the following description may mean an SSB index, a Re-indexing index of cell, or a set of L1-RSRP/L3-RSRP, for example. The SSB index in each drawing may be replaced with a CSI-RS index. In each drawing, for example, a report related to one serving cell and a report (s) related to one or more non-serving cell (s) may be included. An RSRP may be replaced with an SINR.

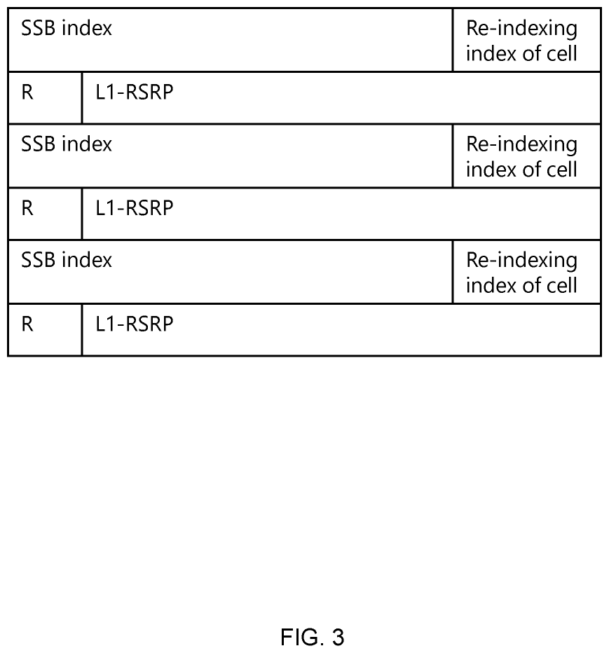

FIG. 3 is a diagram to show a first example of a MAC CE used for CSI report. In the example in FIG. 3, a new ID (Re-indexing index of cell) and an L1-RSRP corresponding to each SSB index are reported. First report (SSB index, Re-indexing index of cell, and L1-RSRP) may relate to the serving cell, and second report and third report may relate to non-serving cells. One of the SSB indices in FIG. 3 may be an SSB index of the best beam of the non-serving cells.

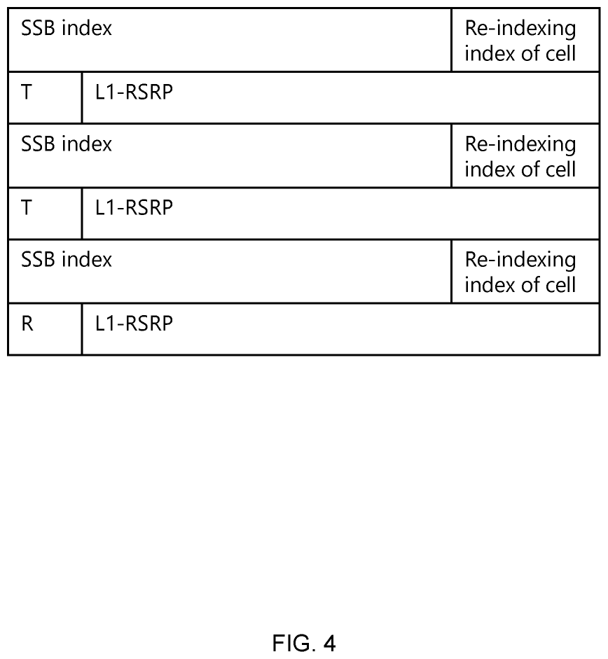

FIG. 4 is a diagram to show a second example of the MAC CE used for the CSI report. “T” in FIG. 4 is a flag indicating whether a report in the next octet (eight bits) is present for the non-serving cell. Otherwise, FIG. 4 is similar to FIG. 3.

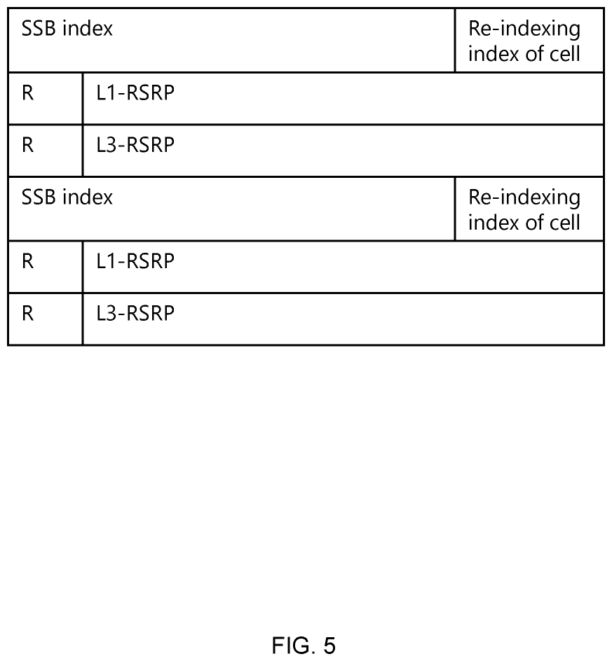

FIG. 5 is a diagram to show a third example of the MAC CE used for the CSI report. In the example in FIG. 5, an L1-RSRP and an L3-RSRP are included in each report. The number of reports is two but may be three as in FIGS. 3 and 4. Otherwise, FIG. 5 is similar to FIG. 3.

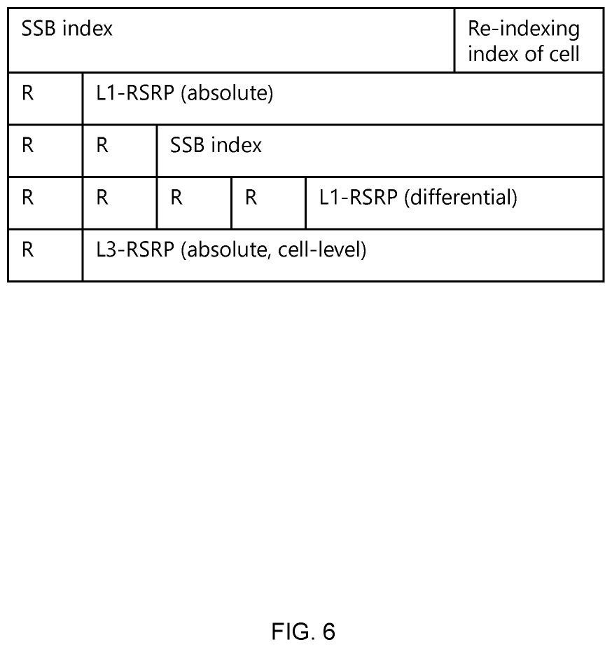

FIG. 6 is a diagram to show a fourth example of the MAC CE used for the CSI report. An L1-RSRP (absolute) in the example in FIG. 6 is an absolute value (largest value). The L1-RSRP (differential) is the difference between the L1-RSRP of the second SSB index (beam) and the first L1-RSRP (absolute). An L3-RSRP (absolute, cell-level) is an absolute value (largest value) of a cell-level (each cell) L3-RSRP.

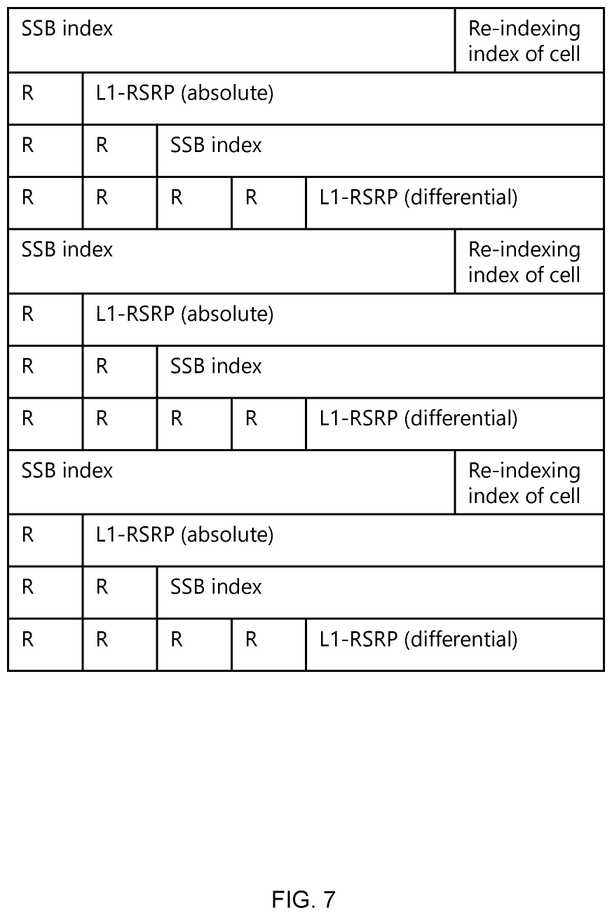

FIG. 7 is a diagram to show a fifth example of the MAC CE used for the CSI report. In the example in FIG. 7, the contents excluding the L3-RSRP from the example in FIG. 6 are mapped for each of three cells.

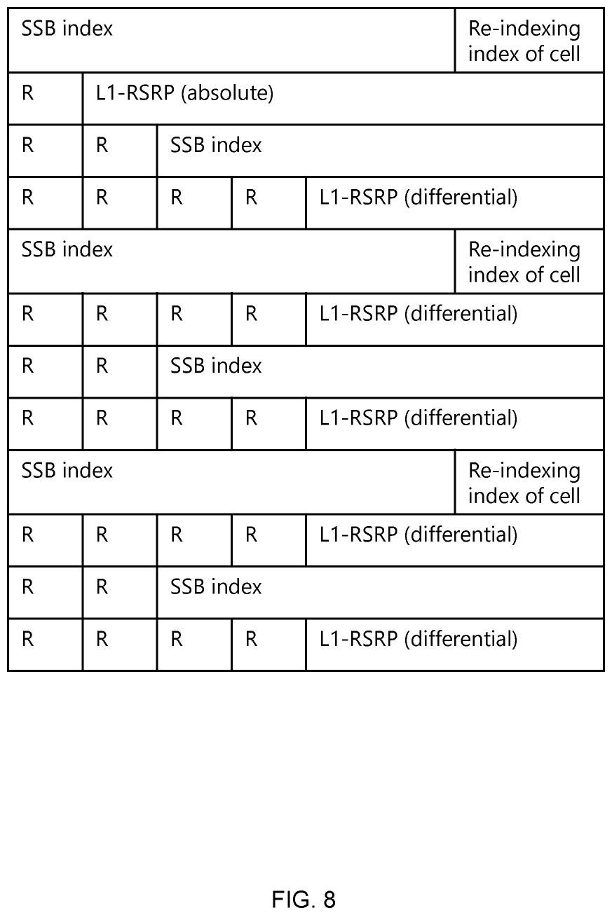

FIG. 8 is a diagram to show a sixth example of the MAC CE used for the CSI report. In FIG. 8, a report for the first cell (e.g., the serving cell) is similar to that in FIG. 7, but an L1-RSRP (differential) is included instead of an L1-RSRP (absolute) for each of the second and third cells (e.g., non-serving cells). For example, the L1-RSRP (differential) may be a measurement result of each beam and may be the difference from the L1-RSRP (absolute) of the first cell.

### <Others>

When the first aspect of the first embodiment is applied, to be able to trigger both an RRM report and a CSI report, the UE may separately report an RRM report (RRC Information Element (IE)) and a CSI report (MAC CE). Alternatively, the UE may include an L3 report of an RRM in a MAC CE to report information of the RRM and CSI in the MAC CE collectively.

A trigger of a CSI report by an event may be applied only to an L1-RSRP report in a non-group-based CSI report, L1-RSRP and L1-SINR reports in a non-group-based CSI report, an L1-RSRP report in each of both of non-group-based and group-based CSI reports, or an L1-RSRP or L1-SINR report in each of both of non-group-based and group-based CSI reports.

When a group-based CSI report is configured and a CSI report to be triggered by an event in the first aspect of the first embodiment is configured, only a non-group-based CSI report may be considered (used), or a group-based CSI report may be used according to the function of the UE, for the CSI report. An event in the second aspect may be used as the event. One or a plurality of beam groups may be reported for each cell.

### <UE Capability>

The UE may report (transmit) at least one UE capability (UE capability information) of (1) to (6) below and receive an indication corresponding to the report by DCI/MAC CE/higher layer signaling or the like. Note that the event may be, for example, at least one event of the events described in the first embodiment.
(1) Whether to support an event to trigger an aperiodic CSI report of a non-serving cell.
(2) The number of non-serving cells to be configured/reported for an aperiodic CSI report (s) triggered by an event (s).
(3) The number of beams (the number of L1-RSRP/L3-RSRP reports) per non-serving cell (or of all the serving cells) to be configured/reported for an aperiodic CSI report triggered by an event
(4) Whether to support a new MAC CE (s) (for example, at least one of the examples in FIG. 3 to FIG. 8) for an aperiodic CSI report (s).
(5) Whether to support an L3-RSRP report in a CSI report.
(6) Whether to support an event to trigger a group-based aperiodic CSI report.

### <CSI Report Using New ID (Re-Indexing Index of Cell)>

The UE may receive a configuration of a specific index (new ID: Re-indexing index of cell) created based on a physical cell ID (Physical Cell Identifier (PCI)) that is different from the physical cell ID and indicating a serving cell or a non-serving cell, and control transmission of a channel state information report (CSI report) corresponding to the configured specific index.

### (1-Bit Indicator)

A 1-bit indicator indicating a serving cell/non-serving cell may be used. For example, “0” may indicate a serving cell, and “1” may indicate a non-serving cell. Alternatively, “1” may indicate a serving cell, and “0” may indicate a non-serving cell.

### (New ID)

As information indicating a serving cell/non-serving cell, a new ID index (for example, an index re-created (re-indexed, re-numbered) indicating a non-serving cell, a group ID of a CMR) or a PCI (PCI to be used directly) may be used. The new ID may be configured only for a serving cell and a non-serving cell (s) used by (available for) the UE. In other words, the new ID uses fewer bits than those of the total of a serving cell and a non-serving cell (s) or a PCI and can hence reduce the number of bits.

This new ID may depend on RS configuration signaling (CSI report configuration/CSI resource configuration). With this new ID, for example, “0” may indicate a serving cell, “1” may indicate non-serving cell #1, and “2” may indicate non-serving cell #2. In other words, this new ID may indicate any of the serving cell and one or more non-serving cells.

The index re-created and indicating a non-serving cell may be associated with part of the PCI. By using the index re-created, instead of the PCI, the number of information bits can be reduced, and the overhead of RRC signaling can hence be reduced. The index re-created may be referred to as a re-created index.

When the number of non-serving cells is one, the new ID may be information similar to the 1-bit indicator described above. In other words, the new ID may mean the 1-bit indicator described above. The parameter name of the new ID may be any term without being limited to “New ID,” “Re-indexing index of cell,” and the like.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

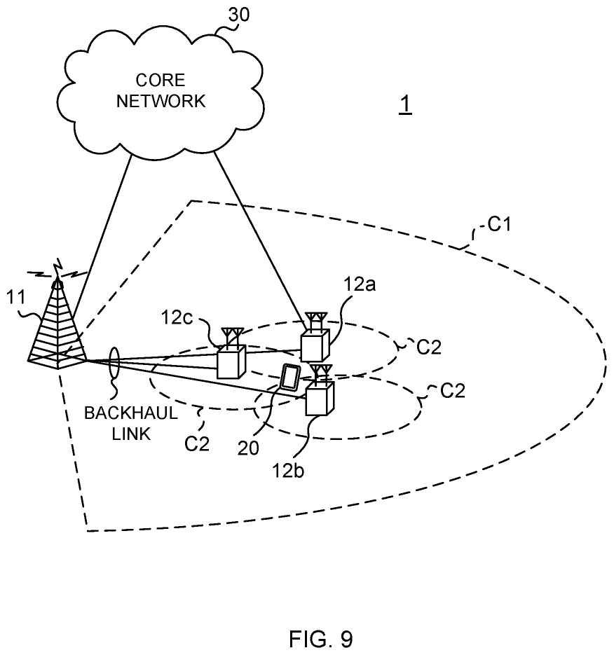

FIG. 9 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

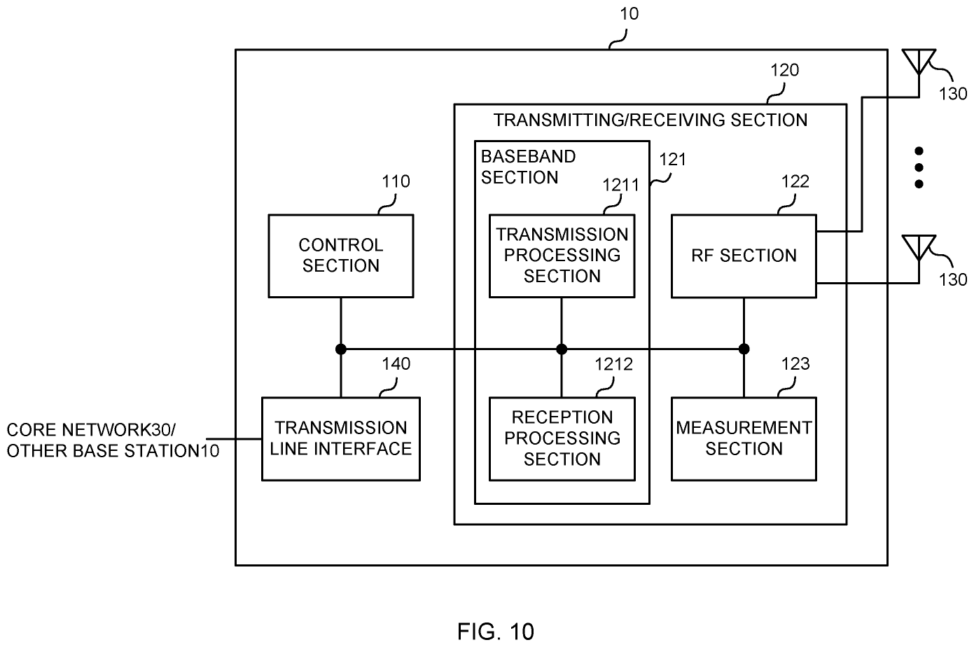

FIG. 10 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that, when it is determined that an event to be a trigger of an aperiodic CSI report occurs, based on a measurement result related to channel state information (CSI) of at least one of a serving cell, a neighbour cell, a primary cell, a primary secondary cell, and a secondary cell, the transmitting/receiving section 120 receives the aperiodic CSI report.

The control section 110 may control reception processing of the transmitting/receiving section 120.

### (User Terminal)

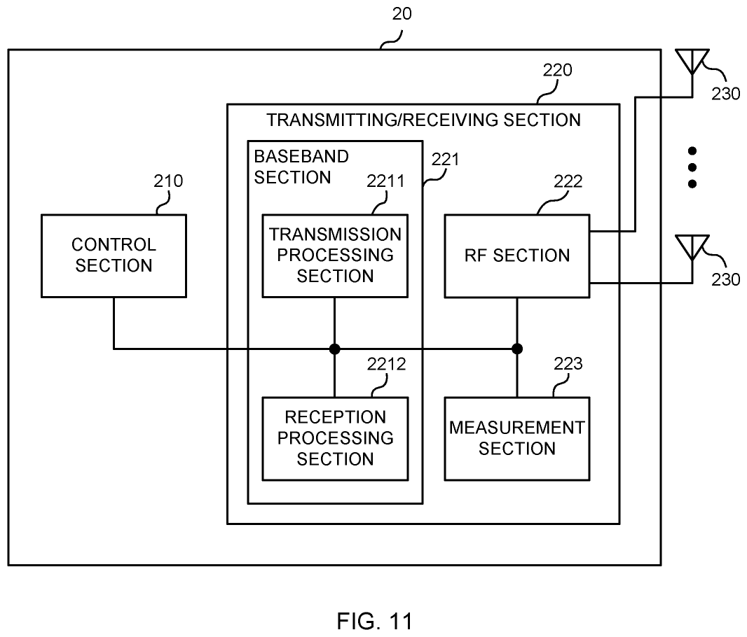

FIG. 11 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that, when an event occurs, the transmitting/receiving section 220 may transmit an aperiodic CSI report. When the event occurs, the transmitting/receiving section 220 may transmit the aperiodic CSI report by using a Medium Access Control Control Element (MAC CE).

The control section 210 may determine whether an event to be a trigger of a CSI report occurs, based on a measurement result related to channel state information (CSI) of at least one of a serving cell, a neighbour cell, a primary cell, a primary secondary cell, and a secondary cell.

A condition for the event may be the same as a condition for an event to be a trigger of a Radio Resource Management (RRM) report. The event may occur based on a measurement result of a reference signal received power in layer 1 (L1-RSRP).

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

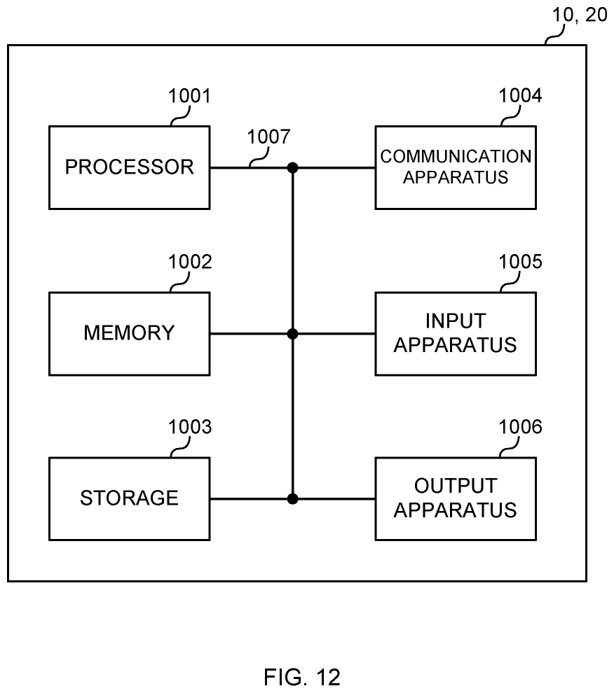

For example, a base station, a user terminal, and so on according to one embodiment of the present disclosure may function as a computer that executes the processes of the radio communication method of the present disclosure. FIG. 12 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell, “a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a mobile body or a mobile body itself, and so on. The mobile body may be a vehicle (for example, a car, an airplane, and the like), may be a mobile body which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IOT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “sidelink”). For example, an uplink channel, a downlink channel, and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

This application is based on Japanese Patent Application No. 2021-067096 filed on Apr. 12, 2021. The entire content of the application is incorporated herein.

1. A terminal comprising:
a control section that determines whether an event to be a trigger of a CSI report occurs, based on a measurement result related to channel state information (CSI) of at least one of a serving cell, a neighbour cell, a primary cell, a primary secondary cell, and a secondary cell; and
a transmitting section that transmits an aperiodic CSI report when the event occurs.

2. The terminal according to claim 1, wherein a condition for the event is same as a condition for an event to be a trigger of a Radio Resource Management (RRM) report.

3. The terminal according to claim 1, wherein the event occurs based on a measurement result of a reference signal received power in layer 1 (L1-RSRP).

4. The terminal according to claim 1, wherein the transmitting section transmits the aperiodic CSI report by using a Medium Access Control Control Element (MAC CE), when the event occurs.

5. A radio communication method for a terminal, the radio communication method comprising:
determining whether an event to be a trigger of an aperiodic CSI report occurs, based on a measurement result related to channel state information (CSI) of at least one of a serving cell, a neighbour cell, a primary cell, a primary secondary cell, and a secondary cell; and
transmitting the aperiodic CSI report when the event occurs.

6. A base station comprising:
a receiving section that, when it is determined that an event to be a trigger of an aperiodic CSI report occurs, based on a measurement result related to channel state information (CSI) of at least one of a serving cell, a neighbour cell, a primary cell, a primary secondary cell, and a secondary cell, receives the aperiodic CSI report; and
a control section that controls reception of the aperiodic CSI report.

7. The terminal according to claim 2, wherein the event occurs based on a measurement result of a reference signal received power in layer 1 (L1-RSRP).

8. The terminal according to claim 2, wherein the transmitting section transmits the aperiodic CSI report by using a Medium Access Control Control Element (MAC CE), when the event occurs.

9. The terminal according to claim 3, wherein the transmitting section transmits the aperiodic CSI report by using a Medium Access Control Control Element (MAC CE), when the event occurs.
